(19) United States
(12) Patent Application Publication
(10) Pub. No.: US 2025/0077067 A1
(43) Pub. Date: Mar. 6, 2025

(54) METHOD AND APPARATUS FOR SUPPORT SYSTEM AUTOMATION WORKFLOW

(71) Applicant: Rakuten Symphony, Inc., Tokyo (JP)

(72) Inventor: Kumeresh KHANNA, Singapore (SG)

(73) Assignee: Rakuten Symphony, Inc., Tokyo (JP)

(21) Appl. No.: 17/997,990

(22) PCT Filed: Aug. 19, 2022
(86) PCT No.: PCT/US2022/040836

§ 371 Date: Nov. 4, 2022

(51) Int. Cl. G06F 3/0486; G06F 3/04847

(52) U.S. Cl. CPC G06F 3/0486; G06F 3/04847

(57) ABSTRACT

A method performed by at least one processor in user equipment (UE) includes displaying a presentation user interface received from a server, the presentation interface including (i) a symbol display that includes one or more symbols, and (ii) a working area. The method further includes selecting a first symbol from the symbol display and moving the first symbol to the working area. The method further includes selecting a second symbol from the symbol display and moving the second symbol to the working area. The method further includes connecting, in the working area, the first symbol to the second symbol forming a workflow topology. The method further includes transmitting the workflow topology to the server.

### TECHNICAL FIELD

The present disclosure relates generally to communication systems, and more particularly to methods and apparatuses for support system automation workflow.

### BACKGROUND

For a support system (e.g., business support system (BSS), etc.) transformation, implementation and execution of workflow is traditionally time consuming and complicated. Particularly, the traditional method of gathering requirements, conducting analysis on which core components may require changes, and subsequently going through the software development or change request process is ineffective. There is a need to execute use cases in a simplified, low cost, and quick to market approach. Particularly, related art technologies do not provide a BSS Automation Workflow engine as a product to configure and execute use cases. Improvements are presented herein.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for BSS automated workflow are disclosed by the present disclosure.

According to an exemplary embodiment, a method performed by at least one processor in user equipment (UE) includes displaying a presentation user interface received from a server, the presentation interface including (i) a symbol display that includes one or more symbols, and (ii) a working area. The method further includes selecting a first symbol from the symbol display and moving the first symbol to the working area. The method further includes selecting a second symbol from the symbol display and moving the second symbol to the working area. The method further includes connecting, in the working area, the first symbol to the second symbol forming a workflow topology. The method further includes transmitting the workflow topology to the server.

According to an exemplary embodiment, a method performed by at least one processor in a server includes providing a presentation user interface to user equipment (UE), the presentation interface including (i) a symbol display that includes one or more symbols, and (ii) a working area. The method further includes receiving, from the UE, a workflow topology specifying an interconnection between at least a first symbol from the one or more symbols and a second symbol from the one or more symbols, the first symbol associated with a first microservice, the second symbol associated with a second microservice. The method further includes generating a workflow schedule for at least the first microservice and the second microservice. The method further includes executing at least the first microservice and the second microservice in accordance with the workflow schedule.

According to an exemplary embodiment, a device includes at least one memory configured to store computer program code, and at least one processor configured to access said at least one memory and operate as instructed by said computer program code. The computer program code includes presentation interface displaying code configured to cause at least one of said at least one processor to display a presentation user interface received from a server, the presentation interface including (i) a symbol display that includes one or more symbols, and (ii) a working area. The computer program code further includes first selecting code configured to cause at least one of said at least one processor to select a first symbol from the symbol display and moving the first symbol to the working area. The computer program code further includes second selecting code configured to cause at least one of said at least one processor to select a second symbol from the symbol display and moving the second symbol to the working area. The computer program code further includes connecting code configured to cause at least one of said at least one processor to, in the working area, connect the first symbol to the second symbol forming a workflow topology. The computer program code further includes transmitting code configured to cause at least one of said at least one processor to transmit the workflow topology to the server.

According to an exemplary embodiment, a server includes at least one memory configured to store computer program code; and at least one processor configured to access said at least one memory and operate as instructed by the computer program code. The computer program code includes presentation user interface providing code configured to cause at least one of said at least one processor to provide a presentation user interface to user equipment (UE), the presentation interface including (i) a symbol display that includes one or more symbols, and (ii) a working area. The computer program code further includes receiving code configured to cause at least one of said at least one processor to receive, from the UE, a workflow topology specifying an interconnection between at least a first symbol from the one or more symbols and a second symbol from the one or more symbols, the first symbol associated with a first microservice, the second symbol associated with a second microservice. The computer program code further includes generating code configured to cause at least one of said at least one processor to generate a workflow schedule for at least the first microservice and the second microservice. The computer program code further includes executing code configured to cause at least one of said at least one processor to execute at least the first microservice and the second microservice in accordance with the workflow schedule.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 illustrates a diagram of an example BSS architecture, in accordance with various embodiments of the present disclosure.

FIG. 2 is a diagram of an example processing device in accordance with various embodiments of the present disclosure.

FIG. 3A is a schematic diagram of an example communication system, in accordance with various embodiments of the present disclosure.

FIG. 3B is a diagram of an example environment in which systems and/or methods, described herein, may be implemented, in accordance with various embodiments of the present disclosure.

FIG. 4 illustrates an example BSS Automation Workflow product, in accordance with various embodiments of the present disclosure.

FIG. 5 illustrates an example user interface, in accordance with various embodiments of the present disclosure.

FIGS. 6-9 illustrate example use cases, in accordance with various embodiments of the present disclosure.

FIG. 10 illustrates an example workflow schedule, in accordance with various embodiments of the present disclosure.

FIG. 11 illustrates an example sequence diagram of an embodiment of creating a workflow topology.

FIG. 12 illustrates an example sequence diagram of an embodiment of creating a new microservice.

FIG. 13 illustrates a flow chart of an embodiment of a process for creating a workflow topology.

FIG. 14 illustrates a flow chart of an embodiment of a process for receiving and executing a workflow topology.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

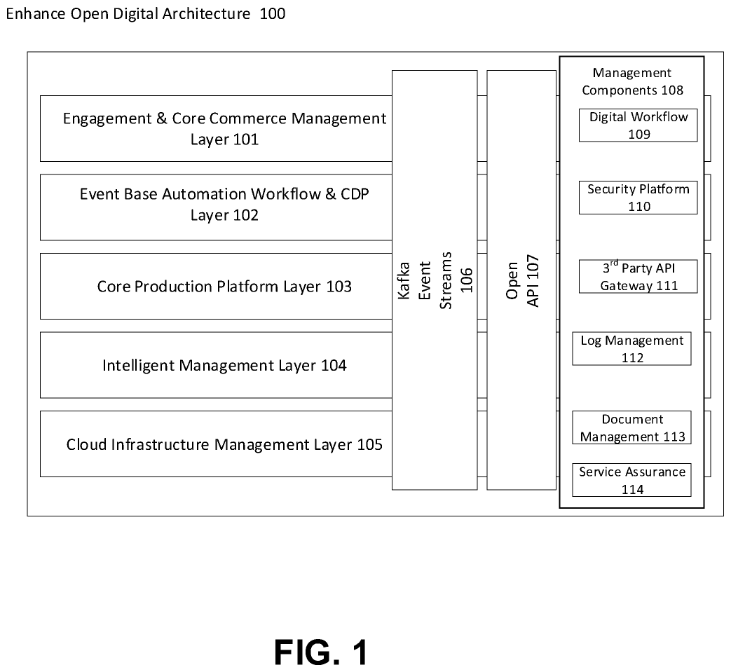

Embodiments of the present disclosure are directed to an enhanced Open Digital Architecture (ODA) including a Automation Workflow layer between the customer engagement and core component layer. FIG. 1 illustrates an embodiment of a BSS architecture in which an event base Automation Workflow and CDP layer 102 is added. In some embodiments, this new product layer automates and creates new use cases for a customer engagement layer without requiring significant changes to the core BSS components.

The embodiments of the present disclosure provide a quicker to market approach since BSS use cases may be configurable based on no code/low code approach at the product layer and not at individual core BSS components. The embodiments of the present disclosure also provide long-term cost benefits achieved by avoiding/reducing change requests at core BSS components, which require a higher total cost and are significantly more time consuming. The embodiments of the present disclosure also allow for the reuse of functional components at a user level without the need for coding.

As shown in FIG. 1, each of the different architecture layers 101-105 may be configured as event stream layers via event stream 106 and may be connected via an open API 107. Additionally, the different architecture layers may include management components 108, including digital workflows 109, security platforms 110, a third Party API gateway 111, log management 112, document management 113, and service assurance 114, each of may provide operational capabilities for the disclosed architecture. For instance, the digital workflows 109 is configured to provide a business workflow (e.g., Business Process Model and Notation (BPMN), etc.), the security platform 110 is configured to provide security-related credentials, the third Party API gateway 111 is configured to provide external component integration, the log management 112 is configured to provide an activity log within the architecture, the document management 113 is configured to manage (e.g., store, retrieve, etc.) documents (e.g., reports, contracts, etc.), and the service assurance 114 is configured to assure the service quality (e.g., monitor the system operation to ensure service quality, etc.)

In some embodiments, the event stream 106 is a Kafka event stream. Kafka is a distributed event store and stream-processing platform. It is an open-source system that provides a unified, high-throughput, low-latency platform for handling real-time data feeds. Kafka can connect to external systems (for data import/export) via Kafka Connect, and provides the Kafka Streams libraries for stream processing applications. Kafka uses a binary TCP-based protocol that is optimized for efficiency and relies on a “message set” abstraction that naturally groups messages together to reduce the overhead of the network roundtrip. While Kafka may be used in some embodiments, other real time data streams may be used, and these streams may also be open-source. The use of real time data streams, and microservices create a new restructuring open-source platform.

In some implementations, the method may be executed on a cloud computing platform. In some implementations, first through fourth computer architecture layers 101-104 (and optionally fifth computer architecture layer 105) may be integrated via an application programming interface, e.g., 107. In some implementations, internal reports on the first through fourth architecture layers 101-104 (and optionally fifth computer architecture layer 105) may be centralized. In some implementations, the method may be executed on an event streaming layer, e.g., a computer architecture layer 106.

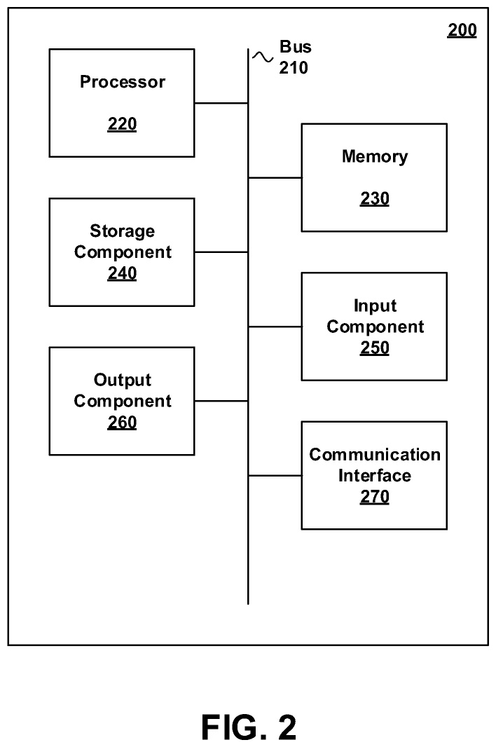

FIG. 2 is diagram of an example device for implementing the embodiments of the present disclosure. Device 200 may correspond to any type of known computer, server, or data processing device. For example, the device 200 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 2, the device 200 may include a set of components, such as a processor 220, a memory 230, a storage component 240, an input component 250, an output component 260, and a communication interface 270.

The bus 210 may comprise one or more components that permit communication among the set of components of the device 200. For example, the bus 210 may be a communication bus, a cross-over bar, a network, or the like. Although the bus 210 is depicted as a single line in FIG. 2, the bus 210 may be implemented using multiple (two or more) connections between the set of components of device 200. The disclosure is not limited in this regard.

The device 200 may comprise one or more processors, such as the processor 220. The processor 220 may be implemented in hardware, firmware, and/or a combination of hardware and software. For example, the processor 220 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 220 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 220 may control overall operation of the device 200 and/or of the set of components of device 200 (e.g., the memory 230, the storage component 240, the input component 250, the output component 260, and the communication interface 270).

The device 200 may further comprise the memory 230. In some embodiments, the memory 230 may comprise a random access memory (RAM), a read only memory (ROM), an electrically erasable programmable ROM (EEPROM), a flash memory, a magnetic memory, an optical memory, and/or another type of dynamic or static storage device. The memory 230 may store information and/or instructions for use (e.g., execution) by the processor 220.

The storage component 240 of device 200 may store information and/or computer-readable instructions and/or code related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 200 may further comprise the input component 250. The input component 250 may include one or more components that permit the device 200 to receive information, such as via user input (e.g., a touch screen, a keyboard, a keypad, a mouse, a stylus, a button, a switch, a microphone, a camera, and the like). Alternatively or additionally, the input component 250 may include a sensor for sensing information (e.g., a global positioning system (GPS) component, an accelerometer, a gyroscope, an actuator, and the like).

The output component 260 of device 200 may include one or more components that may provide output information from the device 200 (e.g., a display, a liquid crystal display (LCD), light-emitting diodes (LEDs), organic light emitting diodes (OLEDs), a haptic feedback device, a speaker, and the like).

The device 200 may further comprise the communication interface 270. The communication interface 270 may include a receiver component, a transmitter component, and/or a transceiver component. The communication interface 270 may enable the device 200 to establish connections and/or transfer communications with other devices (e.g., a server, another device). The communications may be effected via a wired connection, a wireless connection, or a combination of wired and wireless connections. The communication interface 270 may permit the device 200 to receive information from another device and/or provide information to another device. In some embodiments, the communication interface 270 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 270 may provide for communications with another device via a device-to-device (D2D) communication link, such as FlashLinQ, WiMedia, Bluetooth, ZigBee, Wi-Fi, LTE, 5G, and the like. In other embodiments, the communication interface 270 may include an Ethernet interface, an optical interface, a coaxial interface, an infrared interface, a radio frequency (RF) interface, or the like.

The device 200 may perform operations based on the processor 220 executing computer-readable instructions and/or code that may be stored by a non-transitory computer-readable medium, such as the memory 230 and/or the storage component 240. A computer-readable medium may refer to a non-transitory memory device. A memory device may include memory space within a single physical storage device and/or memory space spread across multiple physical storage devices.

Computer-readable instructions and/or code may be read into the memory 230 and/or the storage component 240 from another computer-readable medium or from another device via the communication interface 270. The computer-readable instructions and/or code stored in the memory 230 and/or storage component 240, if or when executed by the processor 220, may cause the device 200 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally or alternatively, a set of (one or more) components shown in FIG. 2 may perform one or more functions described as being performed by another set of components shown in FIG. 2.

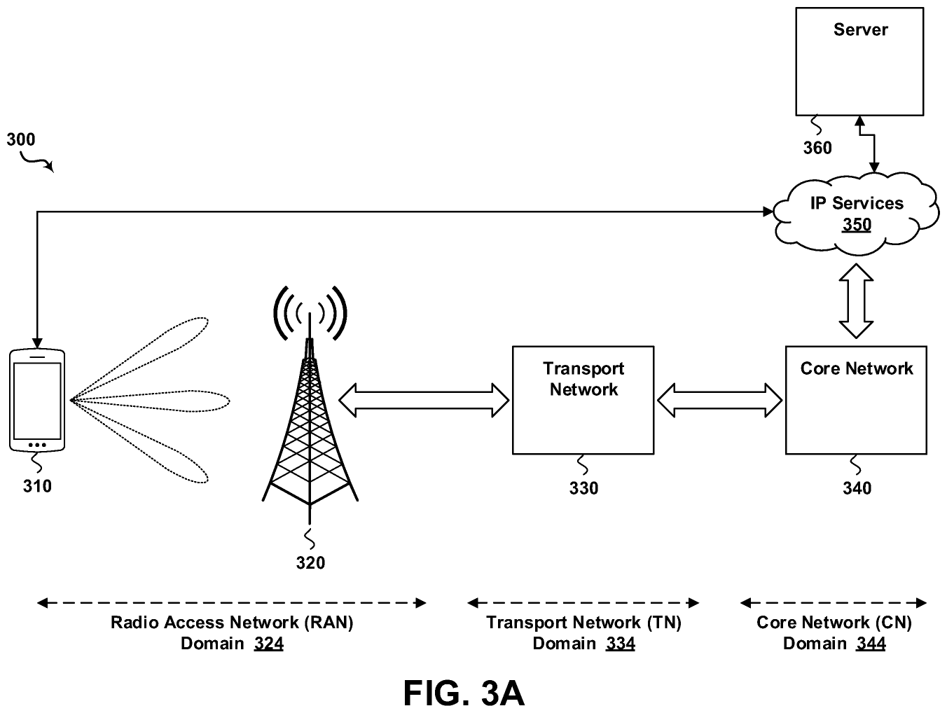

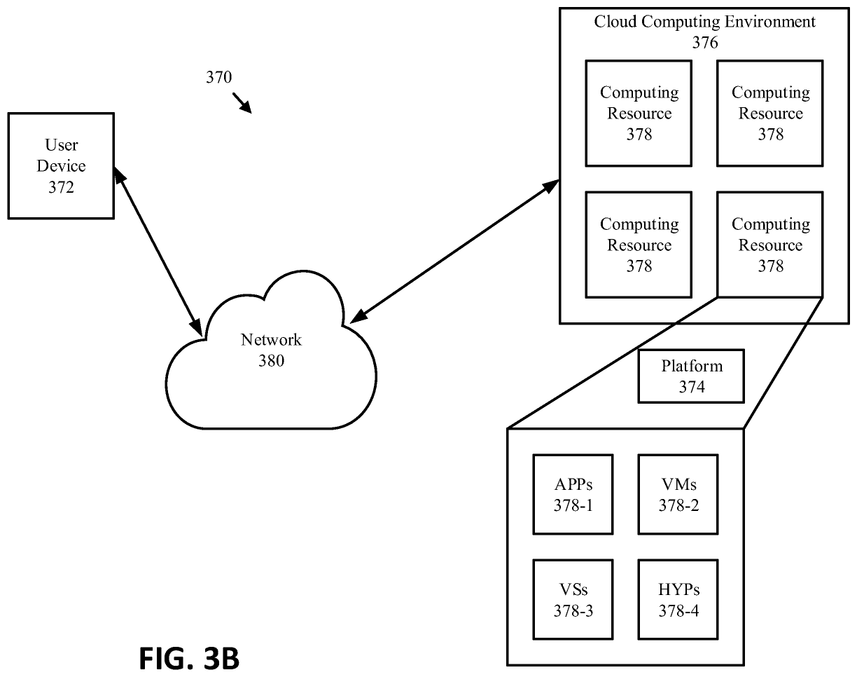

FIG. 3A is a diagram illustrating an example of a communication system, according to various embodiments of the present disclosure. The communication system 300 may include one or more user equipment (UE) 310, one or more base stations 320, at least one transport network 330, at least one core network 340, and one or more servers 360. The device 200 (FIG. 2) may be incorporated in the UE 310 or the server 360.

The one or more UEs 310 may access the at least one core network 340 and/or IP services 350 via a connection to the one or more base stations 320 over a RAN domain 324 and through the at least one transport network 330. The one or more UEs 310 may further connect to the IP services 350 via a Wi-Fi connection or a wired connection. The one or more UEs 310 may upload information to the one or more servers 360 or download information from the one or more servers via the one or more base stations 320 or through a Wi-Fi or wired connection.

Examples of UEs 310 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 310 may be referred to as Internet-of-Things (IoT) devices (e.g., parking meter, gas pump, toaster, vehicles, heart monitor, etc.). The one or more UEs 310 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 320 may wirelessly communicate with the one or more UEs 310 over the RAN domain 324. Each base station of the one or more base stations 320 may provide communication coverage to one or more UEs 310 located within a geographic coverage area of that base station 320. In some embodiments, as shown in FIG. 3A, the base station 320 may transmit one or more beamformed signals to the one or more UEs 310 in one or more transmit directions. The one or more UEs 310 may receive the beamformed signals from the base station 320 in one or more receive directions. Alternatively or additionally, the one or more UEs 310 may transmit beamformed signals to the base station 320 in one or more transmit directions. The base station 320 may receive the beamformed signals from the one or more UEs 310 in one or more receive directions.

The one or more base stations 320 may include macrocells (e.g., high power cellular base stations) and/or small cells (e.g., low power cellular base stations). The small cells may include femtocells, picocells, and microcells. A base station 320, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 320 may be configured to interface (e.g., establish connections, transfer data, and the like) with the at least one core network 340 through at least one transport network 330. In addition to other functions, the one or more base stations 320 may perform one or more of the following functions: transfer of data received from the one or more UEs 310 (e.g., uplink data) to the at least one core network 340 via the at least one transport network 330, transfer of data received from the at least one core network 340 (e.g., downlink data) via the at least one transport network 330 to the one or more UEs 310.

The transport network 330 may transfer data (e.g., uplink data, downlink data) and/or signaling between the RAN domain 324 and the CN domain 344. For example, the transport network 330 may provide one or more backhaul links between the one or more base stations 320 and the at least one core network 340. The backhaul links may be wired or wireless.

The core network 340 may be configured to provide one or more services (e.g., enhanced mobile broadband (eMBB), ultra-reliable low-latency communications (URLLC), and massive machine type communications (mMTC), etc.) to the one or more UEs 310 connected to the RAN domain 324 via the TN domain 334. Alternatively or additionally, the core network 340 may serve as an entry point for the IP services 350. The IP services 350 may include the Internet, an intranet, an IP multimedia subsystem (IMS), a streaming service (e.g., video, audio, gaming, etc.), and/or other IP services.

FIG. 3B is a diagram of an example environment 370 in which systems and/or methods, described herein, may be implemented. As shown in FIG. 3B, the environment 370 may include a user device 372, a platform 374, and a network 380. Devices of environment 370 may interconnect via wired connections, wireless connections, or a combination of wired and wireless connections. In embodiments, any of the functions and operations of the embodiments of the present disclosure may be performed by any combination of elements illustrated in FIG. 3B. The user device 372 may be an example of a UE 310 (FIG. 3A). The user device 372 may be implemented by device 200 (FIG. 2).

User device 372 includes one or more devices capable of receiving, generating, storing, processing, and/or providing information associated with platform 374. For example, user device 372 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 372 may receive information from and/or transmit information to platform 374.

Platform 374 includes one or more devices capable of receiving, generating, storing, processing, and/or providing information. In some implementations, platform 374 may include a cloud server or a group of cloud servers. In some implementations, platform 374 may be designed to be modular such that certain software components may be swapped in or out depending on a particular need. As such, platform 374 may be easily and/or quickly reconfigured for different uses.

In some implementations, as shown, platform 374 may be hosted in cloud computing environment 376. Notably, while implementations described herein describe platform 374 as being hosted in cloud computing environment 376, in some implementations, platform 374 may not be cloud-based (i.e., may be implemented outside of a cloud computing environment) or may be partially cloud-based.

Cloud computing environment 376 includes an environment that hosts platform 374. Cloud computing environment 376 may provide computation, software, data access, storage, etc. services that do not require end-user (e.g., user device 372) knowledge of a physical location and configuration of system(s) and/or device(s) that hosts platform 374. As shown, cloud computing environment 376 may include a group of computing resources 378 (referred to collectively as “computing resources 378” and individually as “computing resource 378”).

Computing resource 378 includes one or more personal computers, a cluster of computing devices, workstation computers, server devices, or other types of computation and/or communication devices. In some implementations, computing resource 378 may host platform 374. The cloud resources may include compute instances executing in computing resource 378, storage devices provided in computing resource 378, data transfer devices provided by computing resource 378, etc. In some implementations, computing resource 378 may communicate with other computing resources 378 via wired connections, wireless connections, or a combination of wired and wireless connections.

As further shown in FIG. 3B, computing resource 378 includes a group of cloud resources, such as one or more applications (“APPs”) 378-1, one or more virtual machines (“VMs”) 378-2, virtualized storage (“VSs”) 378-3, one or more hypervisors (“HYPs”) 378-4, or the like.

Application 378-1 includes one or more software applications that may be provided to or accessed by user device 372. Application 378-1 may eliminate a need to install and execute the software applications on user device 372. For example, application 378-1 may include software associated with platform 374 and/or any other software capable of being provided via cloud computing environment 376. In some implementations, one application 378-1 may send/receive information to/from one or more other applications 378-1, via virtual machine 378-2.

Virtual machine 378-2 includes a software implementation of a machine (e.g., a computer) that executes programs like a physical machine. Virtual machine 378-2 may be either a system virtual machine or a process virtual machine, depending upon use and degree of correspondence to any real machine by virtual machine 378-2. A system virtual machine may provide a complete system platform that supports execution of a complete operating system (“OS”). A process virtual machine may execute a single program, and may support a single process. In some implementations, virtual machine 378-2 may execute on behalf of a user (e.g., user device 372), and may manage infrastructure of cloud computing environment 376, such as data management, synchronization, or long-duration data transfers.

Virtualized storage 378-3 includes one or more storage systems and/or one or more devices that use virtualization techniques within the storage systems or devices of computing resource 378. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 378-4 may provide hardware virtualization techniques that allow multiple operating systems (e.g., “guest operating systems”) to execute concurrently on a host computer, such as computing resource 378. Hypervisor 378-4 may present a virtual operating platform to the guest operating systems, and may manage the execution of the guest operating systems. Multiple instances of a variety of operating systems may share virtualized hardware resources.

Network 380 includes one or more wired and/or wireless networks. For example, network 380 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 3B are provided as an example. In practice, there may be additional devices and/or networks, fewer devices and/or networks, different devices and/or networks, or differently arranged devices and/or networks than those shown in FIG. 3B. Furthermore, two or more devices shown in FIG. 3B may be implemented within a single device, or a single device shown in FIG. 3B may be implemented as multiple, distributed devices. Additionally, or alternatively, a set of devices (e.g., one or more devices) of environment 370 may perform one or more functions described as being performed by another set of devices of environment 370.

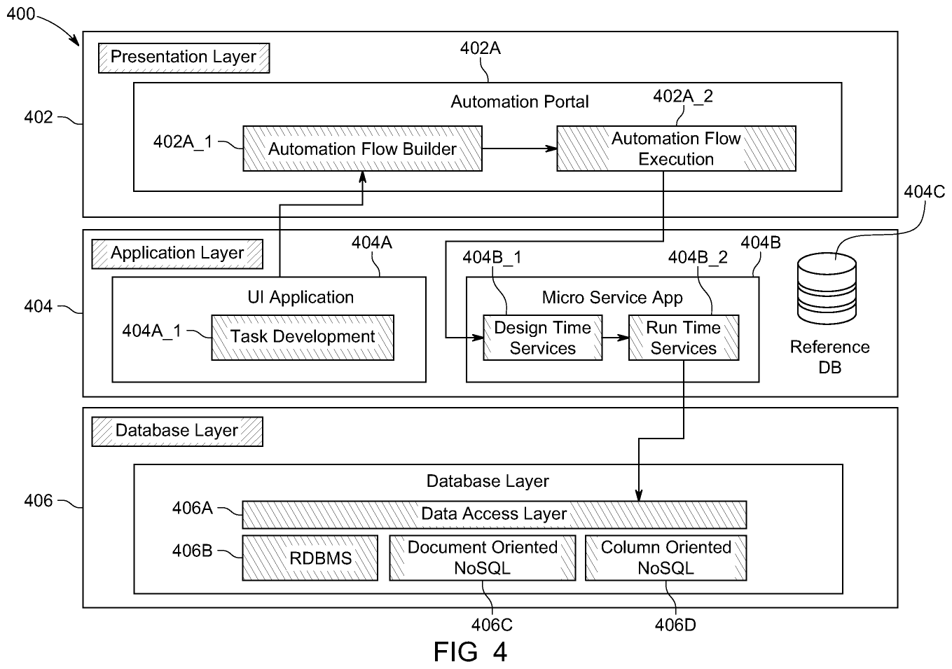

FIG. 4 illustrates an embodiment of a BSS Automation Workflow product 400. The BSS Automation Workflow product 400 may include a presentation layer 402, an application layer 404, and a database layer 406. In some embodiments, the presentation layer 400 may be a portal layer downloaded from the one or more servers 360 to a UE 310 (FIG. 3A). The presentation layer may also be downloaded to user device 372 operating in environment 370. This portal layer may include all the action control or interactive element which the user may drag and drop to build their required use case. The presentation layer may be built using HTML5, JavaScript, and CSS web technologies.

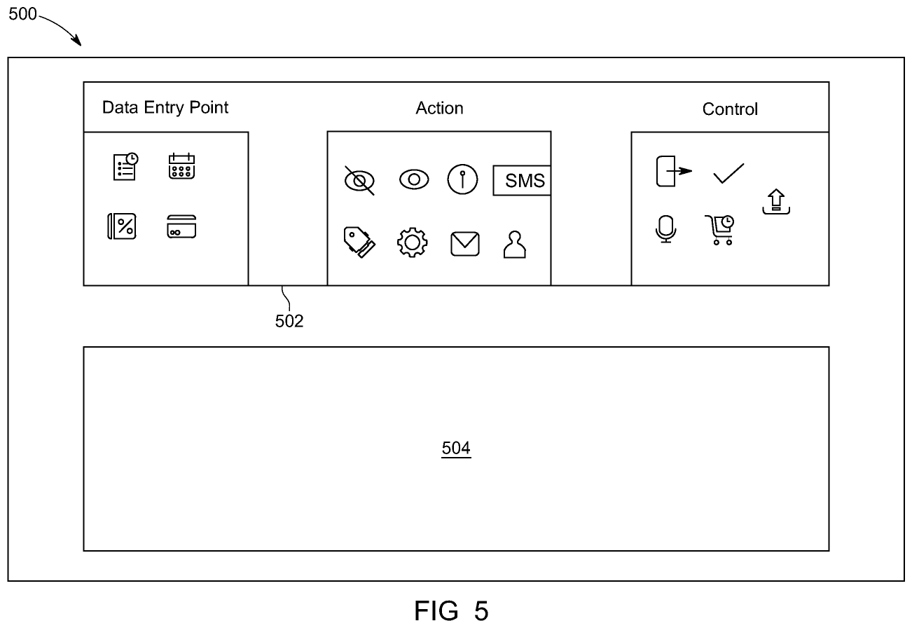

In some embodiments, the presentation layer 400 includes an automation portal 402A that may include an automation flow builder 402A_1. The automation flow builder 402A_1 may include a working canvas for the users to drag & drop a function, configure a parameter, and link them to create a use case. The automation portal 402A may also include an automation flow executor 402A_2 that enables execution of a saved/created workflow. An embodiment of the presentation layer 400 is described in further detail below with respect to FIG. 5.

In some embodiments, the application layer 404 may include the functional business logic that drives the application's core capabilities. This functional business logic may be made available for the users at the presentation layer. These layers may include all the core applications which, in some embodiments, may be deployed as microservices. The application layer 404 may include a UI application 404A with a task development module 404A_1. The task development module 404A_1 may provide a development portal where developers may be able to create new task functions. Upon testing and approval, these new task functions may be published at the automation flow builder 402A_1. This component provides custom build capability to the system. This development module may also include all the run time microservices for the automation flow executor 402A_2.

The application layer may further include a Micro Service App module 404B with design time services 404B_1 and run time services 404B_2. The design time services 404B_1 may schedule execution based on the user configuration at the automation flow builder 402A_1. The run time services 404B_2 may provide the actual execution of a task based on each individual task design. As an example, each task may have its own microservice or set of microservices. The application layer may further include a reference database (DB) 404C that may be an internal DB to keep track of a task schedule and for logging purposes. As an example, the reference DB 404C may store workflows created with the automation flow builder 402A_1.

In some embodiments, the database layer 406 may include a database/data storage system and data access layer 406A. These include No-SQL database and relationship databases which may be used by the application components. The database/data storage system may comprise a relational database management system (RDBMS) 406B, document oriented NoSQL system 406C, and a column oriented NoSQL system 406D.

The data access layer 406A may provide a SQL base logic creation to access any customer data. The data access may be provided through the task configuration by the users. In some embodiments, the user does not have direct access to the data set, but instead, has access to the meta data. The RDBMS 406B may be used to store transaction base data, status log, reference data, and customer segment. The document oriented NoSQL system 406C may be used to store a customer profile (e.g., in JSON format), real time aggregation of customer data, and real time model execution. The column oriented NoSQL system 406D may be used to store transaction data, batch aggregation, and schedule model execution.

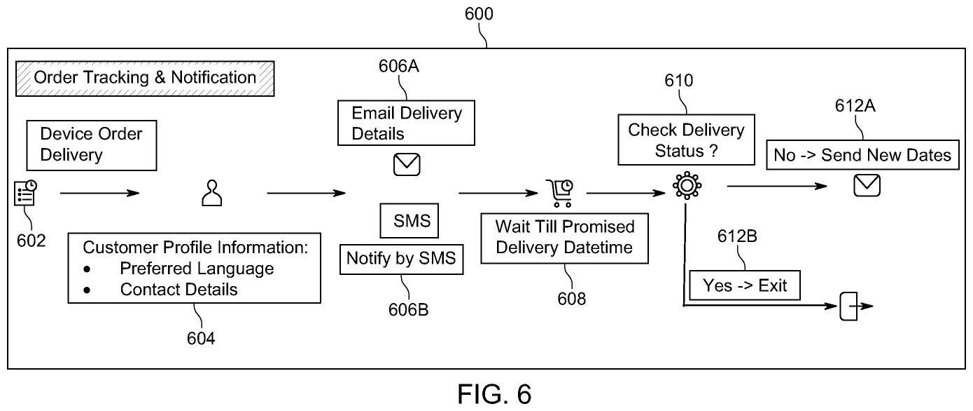

FIG. 5 illustrates an example user interface 500 that provides an embodiment of the automation flow builder 402A_1. The user interface may be downloaded from the application layer 404. The user interface 500 may include a symbol display 502 and a working area 504 (e.g., canvas). The symbol display may include one or more symbols (e.g., building blocks, interactive elements, etc.) that each may be associated with one or more microservices. Particularly, the user interface 500 provides a user a plug and play capability to build a use case. The symbols in the symbol display 502 may be dragged and dropped in the working area 504 and interconnected to each other so as to create a workflow topology. FIGS. 6-9 illustrate example use cases with workflow topologies created using the user interface 500. In some embodiments, the UI application 404A controls access rights to the symbols in the symbol display 502. In this regard, based on a user or customer's profile, access to certain symbols may be denied.

FIG. 6 illustrates an example Order Tracking & Notification use case 600. Each symbol illustrated in the use case 600 may be associated with one or more microservices, and may be presented in a working area (e.g., working area 504). The Order Tracking & Notification use case 600 may start with a symbol representing device order delivery process 602 and proceed to a symbol representing customer profile information process 604 to collect customer information such as a preferred language and/or contact details. The use case 600 may also include symbols representing an email delivery process 606A and a SMS deliver process 606B to provide email and SMS notifications, respectively, to a customer. The use case 600 may include a symbol representing a waiting process 608 that keeps the workflow of use case 600 in a same state until a condition is met such as a specified delivery date. When the delivery date is approached, the use case may include a symbol representing a check delivery status process 610. The use case 600 may include a symbol representing a new delivery date process 612A to schedule a new delivery date which will be initiated if delivery is not completed. The use case 600 may also include a symbol representing an exit process 612B which will be initiated if the delivery is completed.

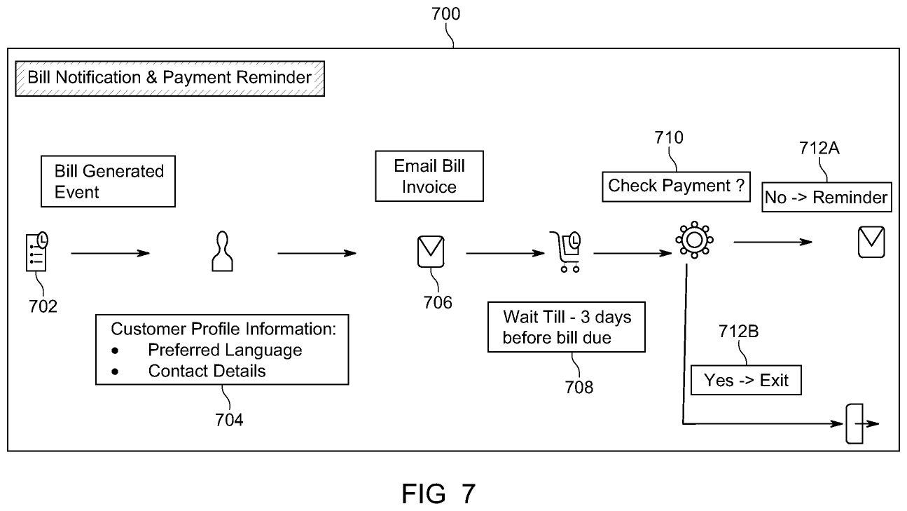

FIG. 7 illustrates an example Bill Notification & Payment Reminder use case 700. Each symbol illustrated in the use case 700 may be associated with one or more microservices, and may be presented in a working area (e.g., working area 504). The use case 700 may start with a symbol representing a bill generated event process 702 that generates a bill. The use case 704 may proceed to a symbol representing a customer profile information process 704. The customer profile information process 704 may be performed by the same microservice that performs the customer profile information process 604 (FIG. 6). Accordingly, by reusing the same microservice, the code for implementing the customer profile information process 704 does not need to be written and produced. The use case 700 may include a symbol representing an email process 706 that emails an invoice 706. The email process 706 may be performed by the same microservice that performs the email process 606A. The use case 700 may include a symbol representing a wait process 708 that keeps the workflow of use case 700 in a same state until a condition is met such as three days before the bill is due.

The wait process 708 may be performed by same microservice that performs the wait process 608, but with a different condition. For example, the wait process 608 may specify a delivery date as a condition, and the wait process 708 may specify a bill due date as a condition. The specified condition may be provided as a parameter to the microservice that performs the wait process 608 and 708. The parameter may be specified at the time a symbol is dragged from the symbol library 502 and dropped in the working area 504. The use case 700 may further include a symbol representing a check payment 710 process that is performed when the condition in the wait process 708 is met. The use case 700 may include a symbol representing a reminder 712A process which will be initiated if a payment is not received. The use case 700 may also include a symbol representing an exit process 712B which will be initiated if the payment is received.

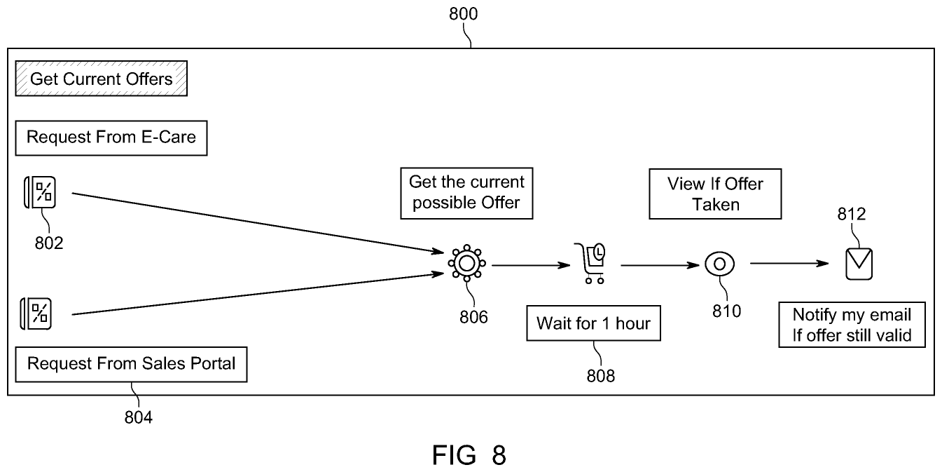

FIG. 8 illustrates an example Get Current Offers use case 800. The use case 800 may include one or more symbols each of which representing one or more processes that request an offer such as request from e-care process 802 or a request from sales portal process 804. The use case 800 may further include a symbol representing a get current possible offer process 806 that provides a current offer in response to the request. The use case 800 may further include a symbol representing a wait process 808 that keeps the use case 808 in the same state until a condition is met (e.g., time condition of one hour). The wait process 808 may be performed by the same microservice that performs the wait process 608 and the wait process 708. The use case 800 may further include a symbol representing an offer taken process 810 that determines whether an offer is taken after leaving the wait process 808. The use case 800 may further include a symbol representing an email process 812 that provide a notification that an offer is still valid in the event it is determined that the offer is not taken.

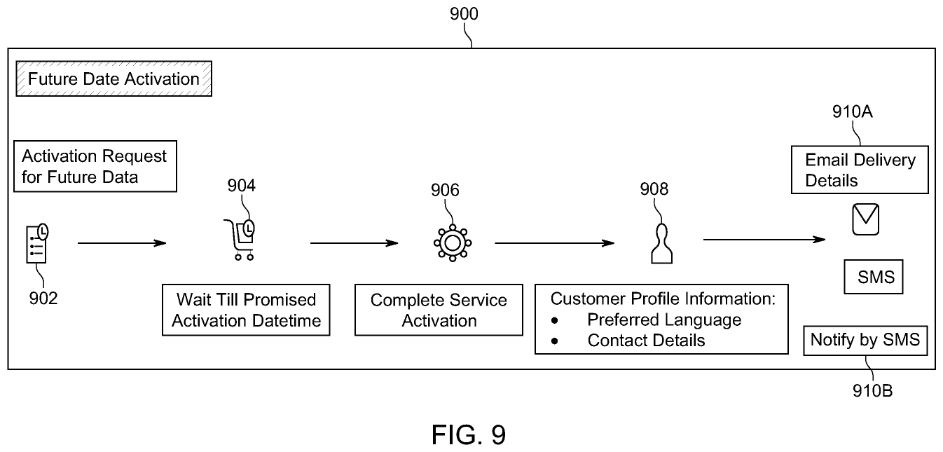

FIG. 9 illustrates an example Future Date Activation use case 900. The use case 900 may start with a symbol representing an activation request for future data process 902. The use case 900 may further include a symbol representing a wait process 904 that keeps the use case 900 in the same state until a condition is met such as a promised activation date time. The wait process 904 may be performed as the same microservice that performs the wait process 608, the wait process 708, and the wait process 808. The use case 900 may further include a symbol representing a complete service activation process 906. The use case 900 may further include a symbol representing a customer profile information process 908 that may be performed by the same microservice that performs the customer profile information process 604. The use case 900 may include a symbol representing an email process 910A and a symbol representing SMS process 910B, which may be performed by the same microservices that perform the email process 606A and the SMS process 606B, respectively.

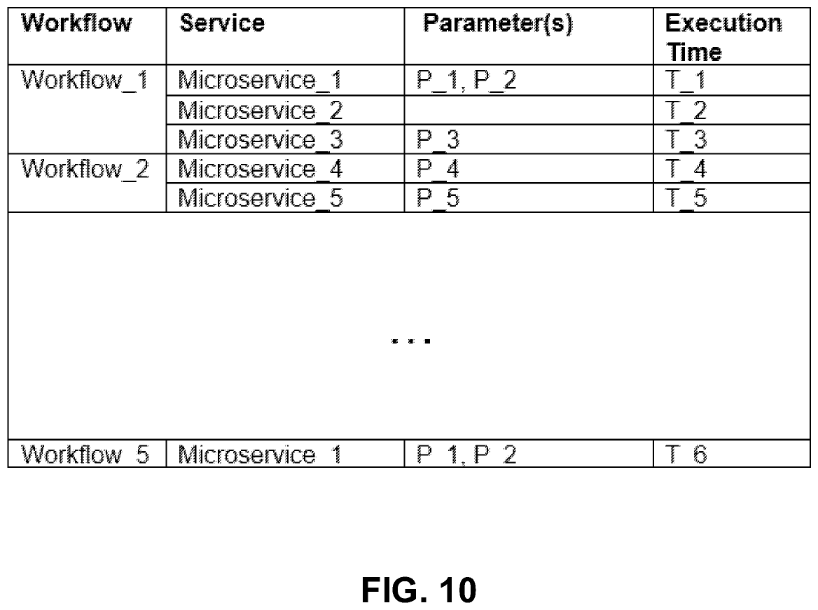

FIG. 10 illustrates an example workflow schedule. The workflow schedule may be generated by the design time services 404B_1. The workflows specified in the workflow schedule may correspond to a specific use case. For example, Workflow_1 may correspond to any one of the use cases illustrated in FIGS. 6-9. The workflow schedule may specify the microservices that are used for each workflow. For example, if Workflow_1 corresponds to use case 600, Microservice_1 may correspond to the device order delivery process 602. The workflow schedule may further specify the parameters used for each microservice. The parameters may be retrieved from the database layer 406 by the run time services 404B_2 as the corresponding microservice is being executed. As illustrated in FIG. 10, a microservice may not have any parameters such as Microservice_2 for Workflow_1. The workflow schedule may further specify the execution time for each microservice. The execution time may correspond to a specific time (e.g., 10 mins, 1 hr, etc.), a specific date (e.g., specific day of week, 5^{th} day of month, etc.), or any other specific condition (e.g., data from customer received, etc.).

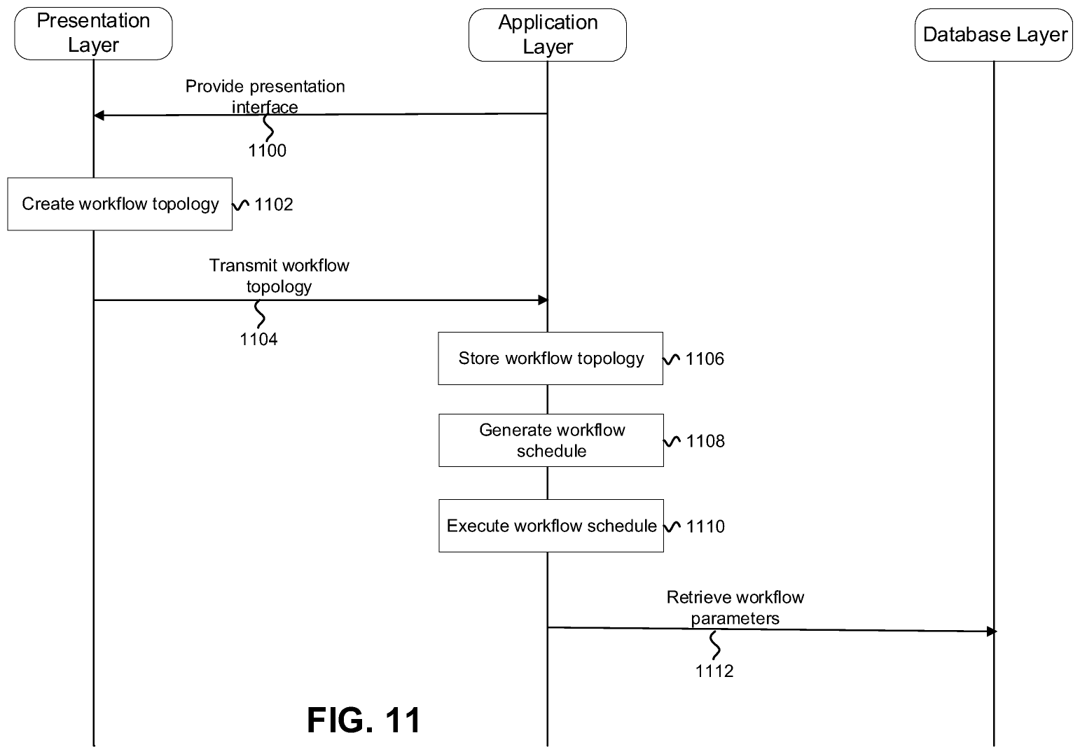

FIG. 11 illustrates an example sequence diagram of an embodiment for generating a workflow topology. The presentation layer may be on a UE 310, and the application layer may be on a server 360 (FIG. 3A). The database layer may also be part of the server 360 or one or more databases remote to the server 360. The application layer provides a presentation interface such as interface 500 (FIG. 5) to the presentation layer at step 1100. At step 1102, the workflow topology is created at the presentation layer such as the workflow topologies provided in the use cases illustrated in FIGS. 6-9. At step S1104 the created workflow topology is transmitted to the application layer and stored at step 1106. At step 1108, a workflow schedule such as the schedule illustrated in FIG. 10 is generated. At step S1110, the workflow schedule is executed. For example, each workflow specified in the workflow schedule is executed in accordance with an execution time of each specified microservice for each workflow. Upon execution of each workflow, one or more workflow parameters are retrieved from database layer at step S1112.

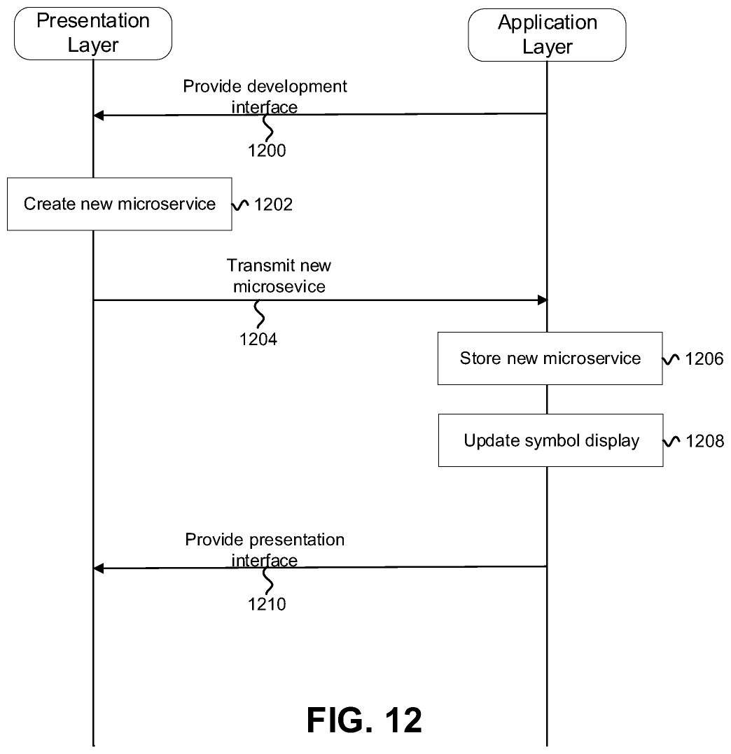

FIG. 12 illustrates an example sequence diagram of an embodiment for developing a new microservice. The presentation layer may be on a UE 310, and the application layer may be on a server 360 (FIG. 3A). The application layer provides to the presentation layer a development interface at 1200. At step 1202, a new microservice is created via the development interface at the presentation layer. At step 1204, the new microservice is transmitted to the application layer where the new microservice is stored at step 1206. At step 1208, the symbol display is updated with the new microservice. As step 1210, the presentation interface with the updated symbol display is provided to the presentation layer.

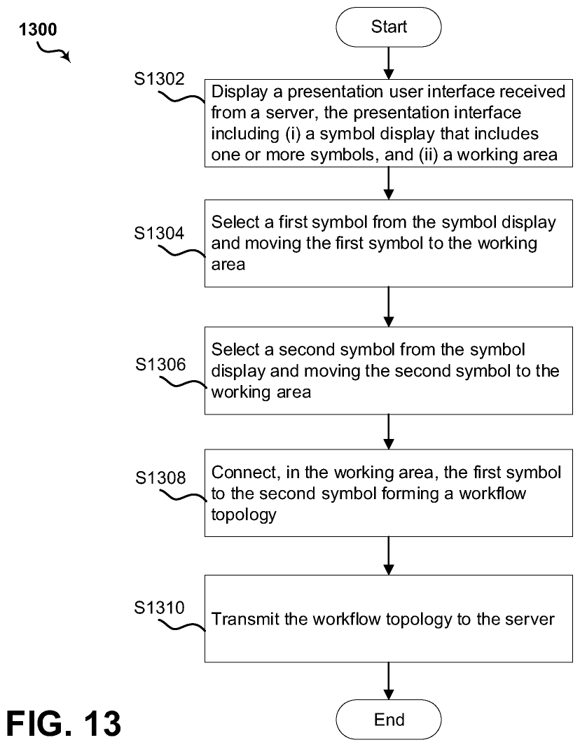

FIG. 13 illustrates an example flow chart of an embodiment of a process 1300 for generating a workflow topology. The process 1300 may be performed on the presentation layer at a UE 310 (FIG. 3A). The process may generally start at step S1302 where a presentation user interface, received from a server, is displayed at the presentation layer. The presentation interface may include a symbol display that includes one or more symbols and a working area, as illustrated in FIG. 5, for example. The process proceeds to step S1304, where a first symbol from the symbol display is selected and moved to the working area. The process proceeds to step 1306, where a second symbol from the symbol display is selected and moved to the working area. The process proceeds to step S1308 where the first symbol and the second symbol are connected in the working area to form a workflow topology. The process proceeds to step 1310 where the workflow is transmitted to the server.

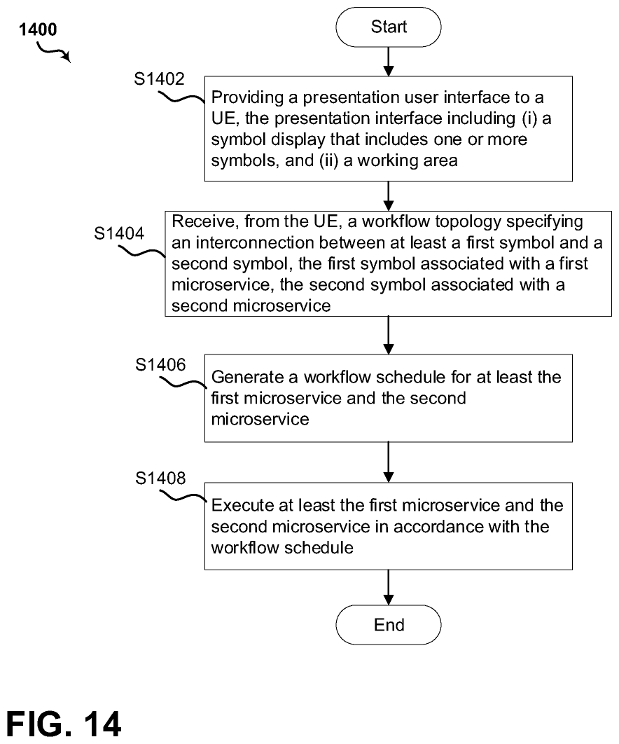

FIG. 14 illustrates an example flow chart of an embodiment of a process 1400 for receiving and executing a workflow topology. The process 1400 may be performed on the application layer at a server 360 (FIG. 3A). The process may generally start at step S1402, where the presentation layer user interface is provided to the UE such as the user interface illustrated in FIG. 5. The process proceeds to step S1404, where a workflow topology is received from the UE such as the workflow topologies illustrated in the use cases of FIGS. 6-9. The workflow topology may specify an interconnection between at least a first symbol and a second symbol associated with first and second microservices, respectively. In another example, a first symbol may be interconnected with second and third symbols in parallel, which indicates that a microservice associated with the first symbol triggers, in parallel, a microservice associated with the second symbol and a microservice associated with the third symbol. The process proceeds to step S1406, where a workflow schedule is generated for at least the first microservice and the second microservice. The process proceeds to step S1408 where at least the first microservice and the second microservice are executed in accordance with the workflow schedule.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:

(1) A method performed by at least one processor in user equipment (UE), the method including: displaying a presentation user interface received from a server, the presentation interface including (i) a symbol display that includes one or more symbols, and (ii) a working area: selecting a first symbol from the symbol display and moving the first symbol to the working area: selecting a second symbol from the symbol display and moving the second symbol to the working area: connecting, in the working area, the first symbol to the second symbol forming a workflow topology; and transmitting the workflow topology to the server.

(2) The method according to feature (1), in which each symbol in the symbol display is associated with a microservice executed by the server.

(3) The method according to feature (1) or (2), in which the first symbol and second symbol are moved to the working area via a drag and drop operation.

(4) The method according to any one of features (1)-(3), in which at least the first symbol in the working area includes one or more configurable parameters.

(5) The method according to any one of features (1)-(4), further including: displaying a development interface including one or more tools for developing a new microservice; and associating a symbol with the new micro service, in which the new microservice is added to the symbol display.

(6) A method performed by at least one processor in a server, the method including: providing a presentation user interface to user equipment (UE), the presentation interface including (i) a symbol display that includes one or more symbols, and (ii) a working area: receiving, from the UE, a workflow topology specifying an interconnection between at least a first symbol from the one or more symbols and a second symbol from the one or more symbols, the first symbol associated with a first microservice, the second symbol associated with a second microservice: generating a workflow schedule for at least the first microservice and the second microservice; and executing at least the first microservice and the second microservice in accordance with the workflow schedule.

(7) The method according to feature (6), further including storing the workflow topology received from the UE in a database.

(8) The method according to feature (6) or (7), in which the executing the first microservice and the second microservice includes retrieving one or more parameters from a database.

(9) The method according to any one of features (6)-(8), further including: providing, to a UE, a development interface including one or more tools for developing a new microservice: receiving, from the UE, the new microservice and a new symbol associated with the new microservice; and adding the new microservice to the display panel.

(10) The method according to any one of features (6)-(9), further including: denying access to at least one symbol in the one or more symbols in the display panel in response to a determination the UE does not have access rights to the at least one symbol.

(11) A device including: at least one memory configured to store computer program code; and at least one processor configured to access said at least one memory and operate as instructed by said computer program code, said computer program code including: presentation interface displaying code configured to cause at least one of said at least one processor to display a presentation user interface received from a server, the presentation interface including (i) a symbol display that includes one or more symbols, and (ii) a working area, first selecting code configured to cause at least one of said at least one processor to select a first symbol from the symbol display and moving the first symbol to the working area, second selecting code configured to cause at least one of said at least one processor to select a second symbol from the symbol display and moving the second symbol to the working area, connecting code configured to cause at least one of said at least one processor to connect, in the working area, the first symbol to the second symbol forming a workflow topology, and transmitting code configured to cause at least one of said at least one processor to transmit the workflow topology to the server.

(12) The device according to feature (11), in which each symbol in the symbol display is associated with a microservice executed by the server.

(13) The device according to feature (11) or (12), in which the first symbol and second symbol are moved to the working area via a drag and drop operation.

(14) The device according to any one of features (11)-(13), in which at least the first symbol in the working area includes one or more configurable parameters.

(15) The device according to any one of features (11)-(14), in which said computer program code further includes: development interface displaying code configured to cause at least one of said at least one processor to display a development interface including one or more tools for developing a new microservice, and associating code configured to cause at least one of said at least one processor to associate a symbol with the new micro service, in which the new microservice is added to the symbol display.

(16) A server including: at least one memory configured to store computer program code; and at least one processor configured to access said at least one memory and operate as instructed by said computer program code, said computer program code including: presentation user interface providing code configured to cause at least one of said at least one processor to provide a presentation user interface to user equipment (UE), the presentation interface including (i) a symbol display that includes one or more symbols, and (ii) a working area, receiving code configured to cause at least one of said at least one processor to receive, from the UE, a workflow topology specifying an interconnection between at least a first symbol from the one or more symbols and a second symbol from the one or more symbols, the first symbol associated with a first microservice, the second symbol associated with a second microservice, generating code configured to cause at least one of said at least one processor to generate a workflow schedule for at least the first microservice and the second microservice, and executing code configured to cause at least one of said at least one processor to execute at least the first microservice and the second microservice in accordance with the workflow schedule.

(17) The server according to feature (16), in which the computer program code further includes storing code configured to cause at least one of said at least one processor to store the workflow topology received from the UE in a database.

(18) The server according to feature (16) or (17), in which the executing code that causes at least one of said at least one processor to execute the first microservice and the second microservice further causes said at least one processor to retrieve one or more parameters from a database.

(19) The server according to any one of features (16)-(18), in which said computer program code further includes: development interface providing code configured to cause at least one of said at least one processor to provide, to a UE, a development interface including one or more tools for developing a new microservice, receiving code configured to cause at least one of said at least one processor to receive, from the UE, the new microservice and a new symbol associated with the new microservice, and adding code configured to cause at least one of said at least one processor to add the new microservice to the display panel.

(20) The server according to any one of features (16)-(19), in which said computer program code further includes: denying code configured to cause at least one of said at least one processor to deny access to at least one symbol in the one or more symbols in the display panel in response to a determination the UE does not have access rights to the at least one symbol.

What is claimed is:

1. A method performed by at least one processor in user equipment (UE), the method comprising:
displaying a presentation user interface received from a server, the presentation interface including (i) a symbol display that includes one or more symbols, and (ii) a working area;
selecting a first symbol from the symbol display and moving the first symbol to the working area;
selecting a second symbol from the symbol display and moving the second symbol to the working area;
connecting, in the working area, the first symbol to the second symbol forming a workflow topology; and
transmitting the workflow topology to the server.

2. The method according to claim 1, wherein each symbol in the symbol display is associated with a microservice executed by the server.

3. The method according to claim 1, wherein the first symbol and second symbol are moved to the working area via a drag and drop operation.

4. The method according to claim 1, wherein at least the first symbol in the working area includes one or more configurable parameters.

5. The method according to claim 1, further comprising:
displaying a development interface including one or more tools for developing a new microservice; and
associating a symbol with the new micro service,
wherein the new microservice is added to the symbol display.

6. A method performed by at least one processor in a server, the method comprising:
providing a presentation user interface to user equipment (UE), the presentation interface including (i) a symbol display that includes one or more symbols, and (ii) a working area;
receiving, from the UE, a workflow topology specifying an interconnection between at least a first symbol from the one or more symbols and a second symbol from the one or more symbols, the first symbol associated with a first microservice, the second symbol associated with a second microservice;
generating a workflow schedule for at least the first microservice and the second microservice; and
executing at least the first microservice and the second microservice in accordance with the workflow schedule.

7. The method according to claim 6, further comprising storing the workflow topology received from the UE in a database.

8. The method according to claim 6, wherein the executing the first microservice and the second microservice includes retrieving one or more parameters from a database.

9. The method according to claim 6, further comprising:
providing, to a UE, a development interface including one or more tools for developing a new microservice;
receiving, from the UE, the new microservice and a new symbol associated with the new microservice; and
adding the new microservice to the display panel.

10. The method according to claim 6, further comprising:
denying access to at least one symbol in the one or more symbols in the display panel in response to a determination the UE does not have access rights to the at least one symbol.

11. A device comprising:
at least one memory configured to store computer program code; and
at least one processor configured to access said at least one memory and operate as instructed by said computer program code, said computer program code including:
presentation interface displaying code configured to cause at least one of said at least one processor to display a presentation user interface received from a server, the presentation interface including (i) a symbol display that includes one or more symbols, and (ii) a working area,
first selecting code configured to cause at least one of said at least one processor to select a first symbol from the symbol display and moving the first symbol to the working area,
second selecting code configured to cause at least one of said at least one processor to select a second symbol from the symbol display and moving the second symbol to the working area,
connecting code configured to cause at least one of said at least one processor to connect, in the working area, the first symbol to the second symbol forming a workflow topology, and
transmitting code configured to cause at least one of said at least one processor to transmit the workflow topology to the server.

12. The device according to claim 11, wherein each symbol in the symbol display is associated with a microservice executed by the server.

13. The device according to claim 11, wherein the first symbol and second symbol are moved to the working area via a drag and drop operation.

14. The device according to claim 11, wherein at least the first symbol in the working area includes one or more configurable parameters.

15. The device according to claim 11, wherein said computer program code further includes:
development interface displaying code configured to cause at least one of said at least one processor to display a development interface including one or more tools for developing a new microservice, and
associating code configured to cause at least one of said at least one processor to associate a symbol with the new micro service,
wherein the new microservice is added to the symbol display.

16. A server comprising:
at least one memory configured to store computer program code; and
at least one processor configured to access said at least one memory and operate as instructed by said computer program code, said computer program code including:
presentation user interface providing code configured to cause at least one of said at least one processor to provide a presentation user interface to user equipment (UE), the presentation interface including (i) a symbol display that includes one or more symbols, and (ii) a working area,
receiving code configured to cause at least one of said at least one processor to receive, from the UE, a workflow topology specifying an interconnection between at least a first symbol from the one or more symbols and a second symbol from the one or more symbols, the first symbol associated with a first microservice, the second symbol associated with a second microservice,
generating code configured to cause at least one of said at least one processor to generate a workflow schedule for at least the first microservice and the second microservice, and
executing code configured to cause at least one of said at least one processor to execute at least the first microservice and the second microservice in accordance with the workflow schedule.

17. The server according to claim 16, wherein the computer program code further includes storing code configured to cause at least one of said at least one processor to store the workflow topology received from the UE in a database.

18. The server according to claim 16, wherein the executing code that causes at least one of said at least one processor to execute the first microservice and the second microservice further causes said at least one processor to retrieve one or more parameters from a database.

19. The server according to claim 16, wherein said computer program code further includes:
development interface providing code configured to cause at least one of said at least one processor to provide, to a UE, a development interface including one or more tools for developing a new microservice,
receiving code configured to cause at least one of said at least one processor to receive, from the UE, the new microservice and a new symbol associated with the new microservice, and
adding code configured to cause at least one of said at least one processor to add the new microservice to the display panel.

20. The server according to claim 16, wherein said computer program code further includes:
denying code configured to cause at least one of said at least one processor to deny access to at least one symbol in the one or more symbols in the display panel in response to a determination the UE does not have access rights to the at least one symbol.
